(19) United States
(12) Patent Application Publication
(10) Pub. No.: US 2005/0281432 A1
(43) Pub. Date: Dec. 22, 2005

(54) Speaker device

(76) Inventor: Minoru Horigome, Tendo-shi (JP)

Correspondence Address: NIXON & VANDERHYE, PC, 901 NORTH GLEBE ROAD, 11TH FLOOR, ARLINGTON, VA, 22203, US

(21) Appl. No.: 11/155,886

(22) Filed: Jun. 20, 2005

(30) Foreign Application Priority Data
Jun. 21, 2004 (JP) 2004-182580

(51) Int. Cl. H04R 25/00

(52) U.S. Cl. 381/412

(57) ABSTRACT

The speaker device includes the magnetic circuit system having an annular plate and magnetic fluid, and a vibration system having a voice coil bobbin and a voice coil. When the speaker device is not driven, the voice coil is located at a predetermined stationary position within the magnetic gap filled with the magnetic fluid. Within the magnetic gap, a recess portion into which the greater part of the magnetic fluid flows is formed in the voice coil or voice coil bobbin. When the speaker device is not driven, the greater part of the magnetic fluid enters the recess portion and forms a stable condition. Thereby, in the case where the edge is formed by soft material, the voice coil is never affected by the buoyant force of the magnetic fluid and reliably held at the predetermined stationary position within the magnetic gap.

### BACKGROUND OF THE INVENTION

1. Field of the Invention

The present invention relates to a speaker device having magnetic fluid.

2. Description of Related Art

Conventionally, there is known a speaker device having magnetic fluid formed by surface-treating ferromagnetic ultra-fine particles of magnetite or the like and dispersing them within a solvent. In such a speaker, for example, a magnetic gap is filled with the magnetic fluid, and a voice coil wound around a voice coil bobbin is located in a predetermined stationary position within the magnetic fluid when the speaker is not driven.

As a speaker of this type, for example, there is known a speaker in which magnetic fluid is interposed within a magnetic pole air gap formed between a pole and a plate and spiral grooves are formed on surfaces of the pole and the plate, which face each other, so as to prevent the magnetic fluid from getting out of the magnetic pole air gap due to the vertical movement of the voice coil (e.g., see Japanese Patent Application Laid-Open under No. 6-14394).

Further, there is known a speaker in which magnetic fluid is injected into a magnetic air gap into which a voice coil of a voice coil bobbin having a vibrating plate bonded is inserted and the heat generated by the voice coil is conducted to a magnetic circuit part via the magnetic fluid for heat radiation (e.g., see Japanese Patent Application Laid-Open under No. 2003-274485).

Still further, there is known a speaker in which a magnetic gap is filled with magnetic fluid and the voice coil is supported by the magnetic fluid at plural points so as to prevent efficiency deterioration at low a frequency band (e.g., see Japanese Patent Application Laid-Open under No. 10-126884).

Still further, as a magnetic circuit for a speaker of this type, for example, there is known a magnetic circuit for speaker with advantageous efficiency, in which a gap between a mounting hole and a mounting member for mounting the magnetic circuit for speaker to a frame or an enclosure is filled with magnetic fluid so that the magnetic flux density in the gap part between a plate and a center pole is not reduced (e.g., see Japanese Utility Model Application Laid-Open under No. 5-60091).

However, in the above-described speakers using magnetic fluid, when an edge for supporting the vibrating plate, voice coil bobbin or the like is formed by a soft material and the supporting force of the edge for supporting the voice coil bobbin or the like is larger than the buoyant force (repulsive force) of the magnetic fluid, the voice coil is pushed out of the magnetic fluid by the buoyant force (repulsive force) of the magnetic fluid if only a slight external force is applied to the voice coil bobbin or the like. Accordingly, in such a speaker, there is a problem that the voice coil cannot be held at a predetermined stationary position within the magnetic gap when the speaker is not driven.

### SUMMARY OF THE INVENTION

As a problem that the invention is to solve, the above problem is taken as an example. An object of the invention is to provide a speaker device capable of preventing a voice coil from displacing from a predetermined stationary position within a magnetic gap due to buoyant force of magnetic fluid even when an edge for supporting a vibrating plate or the like is formed by a very soft material.

According to one aspect of the present invention, there is provided a speaker device including: a magnetic circuit having a magnetic gap; a vibration unit having a voice coil bobbin and a voice coil wound around the voice coil bobbin; and magnetic fluid filled in the magnetic gap, wherein a recess portion is formed in a part of the vibration unit located within the magnetic gap.

In the above speaker device, the voice coil wound around the voice coil bobbin is located within the magnetic gap formed by the magnetic circuit. By supplying an electric signal to the voice coil, the vibration unit vibrates and emits voice. Further, the magnetic gap is filled with the magnetic fluid. The magnetic fluid has a function of radiating heat generated in the magnetic gap and a function of raising the magnetic flux density within the magnetic gap. Here, the vibration unit has the recess portion formed in the part located within the magnetic gap. When the speaker device is not driven, the magnetic fluid flows into recess portion and the voice coil is reliably held at a predetermined position within the magnetic gap. Even in the case where some external force is applied to the vibration unit and the position of the voice coil relative to the magnetic gap is displaced, the magnetic fluid flows into the recess portion, and a force that tends to hold the vibration unit at the predetermined position acts. Therefore, even when an external force is applied, the voice coil is reliably held at a predetermined position within the magnetic gap due to the flow of the magnetic fluid.

In one mode of the above-mentioned speaker device, the voice coil may have a first voice coil and a second voice coil wound around the voice coil bobbin within a winding width of the voice coil, the first voice coil being wound at an upper end side of the voice coil bobbin and the second voice coil being wound at a lower end side of the voice coil bobbin, and the recess portion may be formed by the first voice coil, the second voice coil and the outer circumferential surface of the voice coil bobbin located between the first voice coil and the second voice coil.

In this mode, the voice coil is divided to the upper end side and the lower end side of the voice coil bobbin, and wound around the outer circumferential surface of the voice coil bobbin. Therefore, the voice coil is not wound between the first voice coil wound around the upper end side and the second voice coil wound around the lower end side, and the outer circumferential surface of the voice coil bobbin is exposed. Thereby, the recess portion is formed on the outer circumference of the voice coil within the magnetic gap. The magnetic fluid flows into the recess portion, and thereby the voice coil is reliably held within the magnetic gap.

In yet another mode of the above-mentioned speaker device, the recess portion may be formed by plural openings formed in the voice coil bobbin within a winding width of the voice coil.

In this mode, the voice coil bobbin constituting the vibration unit has plural openings within the winding width around which the voice coil is wound. Therefore, the magnetic fluid flows to enter the plural openings formed in the voice coil bobbin and the voice coil bobbin is reliably held within the magnetic gap.

In yet another mode of the above-mentioned speaker device, the vibration unit may have first and second annular members mounted to the voice coil bobbin at an upper position and a lower position of the voice coil and having thickness thicker than that of the voice coil, and the recess portion may be formed by the first annular member, the second annular member and the outer circumferential surface of the voice coil located between the first annular member and the second annular member.

In this mode, the voice coil is wound around the outer circumferential surface of the voice coil bobbin. Further, the annular members are mounted at the upper and lower portions of the voice coil on the outer circumferential surface of the voice coil bobbin. Since the annular members are thicker than the voice coil, the outer circumference of the annular members protrudes outside the outer circumference of the voice coil, thereby forming the recess portion. That is, the outer circumferential surface becomes the recess of the recess portion. The magnetic fluid flows into the recess portion, and thereby the voice coil is reliably held within the magnetic gap.

According to another aspect of the present invention, there is provided a speaker device including: a magnetic circuit having a magnetic gap; a vibration unit having a voice coil bobbin and a voice coil wound around the voice coil bobbin; and magnetic fluid filled in the magnetic gap, wherein the vibration unit has a shape in which an amount of the magnetic fluid located substantially at the center of a width of the magnetic gap is larger than amounts of the magnetic fluid located in other parts.

In the above-mentioned speaker device, the voice coil wound around the voice coil bobbin is located within the magnetic gap formed by the magnetic circuit. By supplying an electric signal to the voice coil, the vibration unit vibrates and emits voice. Further, the magnetic gap is filled with the magnetic fluid. The magnetic fluid has a function of radiating heat generated in the magnetic gap and a function of raising the magnetic flux density within the magnetic gap. Here, the vibration unit has a shape in which an amount of the magnetic fluid located substantially at the center of a width of the magnetic gap is larger than amounts of the magnetic fluid located in other parts. Thereby, the greater part of the magnetic fluid moves substantially to the center of the magnetic gap and forms a stable condition, and thereby the voice coil can be reliably held within the magnetic gap.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIG. 1 is a sectional view schematically showing a configuration of a speaker device according to a first embodiment of the invention.

FIG. 2 is a side view showing a configuration of a voice coil according to the first embodiment.

FIG. 3 is a partial sectional view of the part around the voice coil according to the first embodiment for explanation of the effect of the invention.

FIGS. 4A to 4C are partial sectional views of the part around the voice coil according to a comparative example for explanation of the effect thereof.

FIG. 5 is a sectional view schematically showing a configuration of a speaker device according to a second embodiment of the invention.

FIG. 6 is a side view showing a configuration of the voice coil according to the second embodiment.

FIG. 7 is a partial sectional view of the part around the voice coil according to the second embodiment for explanation of the effect of the invention.

FIG. 8 is a sectional view schematically showing a configuration of a speaker device according to a third embodiment of the invention.

FIG. 9 is a side view showing a configuration of the voice coil according to the third embodiment.

FIG. 10 is a partial sectional view of the part around the voice coil according to the third embodiment for explanation of the effect of the invention.

### DETAILED DESCRIPTION OF THE PREFERRED EMBODIMENTS

The preferred embodiments of the present invention will now be described below with reference to the attached drawings. The invention prevents a voice coil from displacing from a predetermined stationary position within a magnetic gap due to buoyant force (repulsive force) of magnetic fluid when a speaker device is not driven, even in a case that an edge for supporting a vibrating plate or the like is formed by a soft material.

### First Embodiment

In a speaker device according to a first embodiment, a recess (concave) portion is formed between voice coils. Thereby, the above effect of the invention is obtained.

(Configuration of Speaker Device)

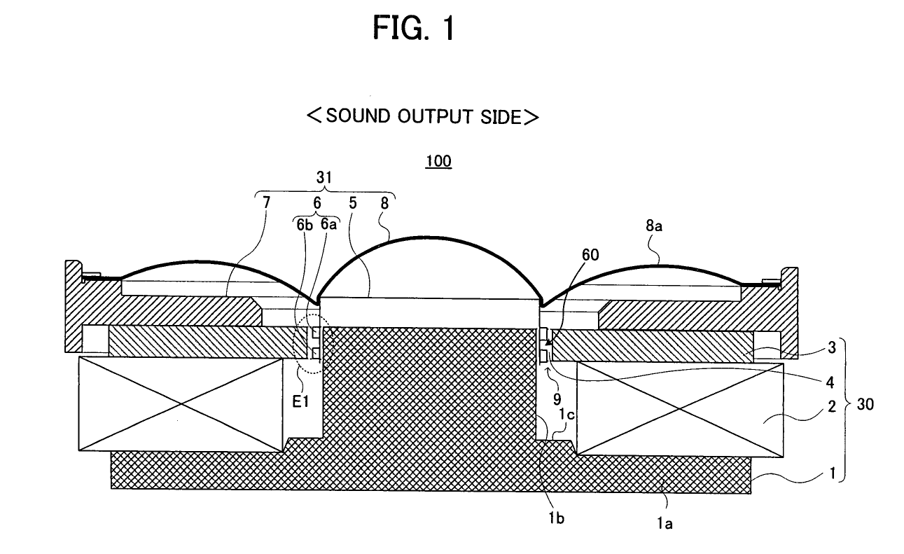

In FIG. 1, an outline configuration of a speaker 100 according to the first embodiment of the invention is schematically shown. FIG. 1 is a sectional view when the speaker device 100 is cut along a plane containing a central axis thereof. Referring to FIG. 1, the configuration of the speaker device 100 of the first embodiment will be described.

The speaker device 100 mainly includes a magnetic circuit system 30 having a pole piece 1, an annular magnet 2, an annular plate 3 and magnetic fluid 4, and a vibration system 31 having a voice coil bobbin 5, a voice coil 6, a frame 7 and a vibrating plate 8.

First, the respective constituent elements of the magnetic circuit system 30 will be described.

The pole piece 1 has substantially an inverted T section. Flatness is ensured at a lower surface of the pole piece 1. The pole piece 1 has a yoke 1a having a flange-like shape, a center pole 1b having a substantially cylindrical shape, and a step portion 1c having a step-like section formed between an outer circumferential wall of a lower end part of the center pole 1b and an upper surface of the yoke 1a.

The annular magnet 2 is disposed on the upper surface of the yoke 1a. An inner circumferential wall of a lower end part of the annular magnet 2 is located at the outer circumferential side of the step portion 1c of the pole piece 1, and the annular magnet 2 is accurately positioned at a predetermined position on the yoke 1a. The annular plate 3 is disposed on the upper surface of the annular magnet 2. A magnetic gap 9 is formed between the inner circumferential wall of the plate 3 and the outer circumferential wall of the center pole 1b. The magnetic gap 9 is filled with the magnetic fluid 4. The magnetic fluid 4 is an extremely stable colloid solution formed by surface-treating ferromagnetic ultra-fine particles of magnetite or the like and dispersing them within a solvent. The magnetic fluid 4 is held in a stable state within the magnetic gap 9 by a magnetic field generated within the magnetic gap 9. The magnetic fluid 4 has a function of radiating heat generated in the voice coil into the air through the plate 3, and a function of raising the magnetic flux density within the magnetic gap 9. Further, when any unnecessary object is going to enter the magnetic fluid 4, the magnetic fluid 4 serves to push the unnecessary object out of the magnetic fluid 4.

In the magnetic circuit system 30, a magnetic circuit is formed by the magnet 2, the plate 3, the pole piece 1 and the magnetic fluid 4, and the magnetic flux of the magnet 2 is concentrated in the magnetic gap 9.

Next, the respective constituent elements of the vibration system 31 will be described.

The voice coil bobbin 5 has a substantially cylindrical shape. The outer circumferential wall of the voice coil bobbin 5 faces the inner circumferential wall of the annular plate 3 with a certain space therebetween. On the other hand, the inner circumferential wall of the voice coil bobbin 5 faces the outer circumferential wall of the upper end part of the pole piece 1 with a certain space therebetween.

The configuration of the voice coil 6 that characterizes the invention will be described later. The voice coil 6 has a pair of positive/negative lead wires (not shown). The positive lead wire is an input wiring of L (or R) channel signal, and the negative lead wire is an input wiring of ground (GND: earth) signal. The respective lead wires are electrically connected to a connection terminal (not shown). To the voice coil 6, electric signals for one channel are input from an amplifier (not shown) side via the connection terminal.

The frame 7 is made of a resin material, for example, and has a substantially annular shape. The frame 7 is located on the upper surface of the annular plate 3. The frame 7 has a function of supporting the vibrating plate 8 etc.

The vibrating plate 8 is a so-called domical vibrating plate, and formed integrally with or independently of an edge portion 8a. Various kinds of materials such as paper, polymer, or metal can be applied to the vibrating plate 8 according to various kinds of application. The outer peripheral edge of the vibrating plate 8, i.e., the lower surface of the outer peripheral edge of the edge portion 8a is fixed to the upper surface of the frame 7. The edge portion 8a is formed by soft material.

In the above-described speaker device 100, when electric signals are input to the connection terminal from the amplifier side, the electric signals are supplied to the voice coil 6 via the respective lead wires of the voice coil 6. Thereby, a driving force is generated in the voice coil 6 within the magnetic gap 9 and the vibrating plate 8 is vibrated in the axis direction of the speaker device 100. Thus, the speaker device 100 emits sound waves to the sound output side.

(Configuration of Voice Coil 6)

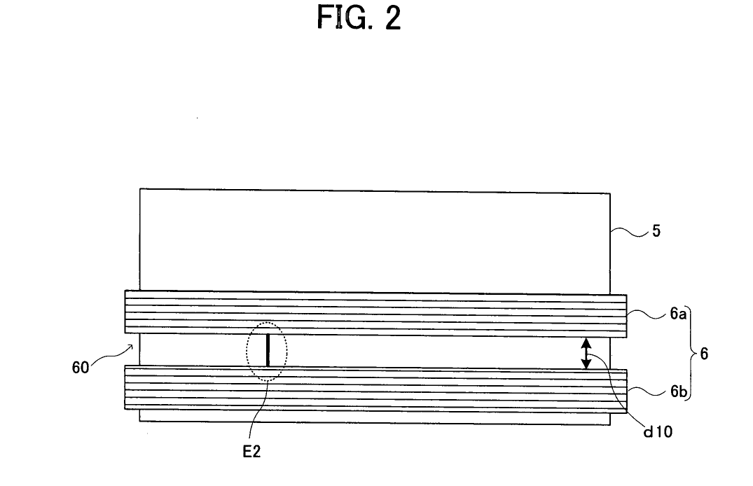

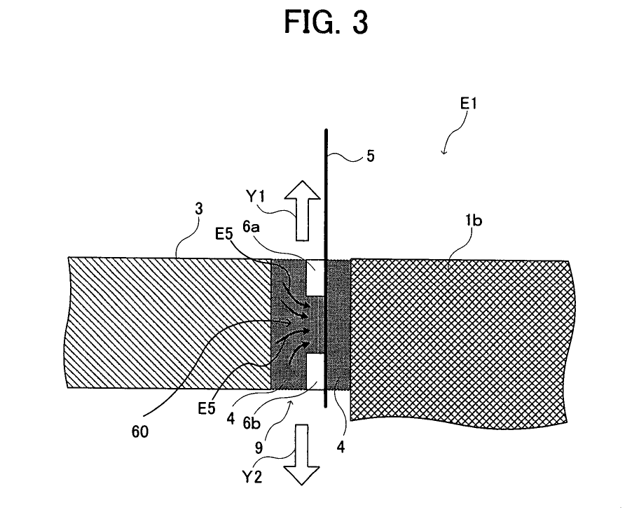

Next, referring to FIGS. 2 and 3, a configuration of the voice coil 6 of the first embodiment that characterizes the invention will be described. FIG. 2 is a side view showing only the configuration of the voice coil 6 wound around the voice coil bobbin 5 in the speaker device 100. FIG. 3 is a sectional view in which the part of the broken line area E1 in FIG. 1 is enlarged.

The voice coil 6 has a first voice coil 6a and a second voice coil 6b. The first voice coil 6a and the second voice coil 6b are formed by an identical lead wire and they are wound around the outer circumferential wall near the lower end part of the voice coil bobbin 5 and spaced at a certain spacing d10.

Note that the first voice coil 6a and the second voice coil 6b are vertically connected with each other in a position at the part of the broken line area E2. That is, the voice coil 6 is formed by winding one electric wire around the voice coil bobbin 5 within the winding width corresponding to the width of the magnetic gap 9 in a manner divided to the upper end side and the lower end side. By the configuration, a recess (concave) portion 60 is formed by the first voice coil 6a, the second voice coil 6b and the outer circumferential wall of the voice coil bobbin 5 located therebetween.

Further, the magnetic gap 9 formed between the inner peripheral edge of the annular plate 3 and the outer circumferential wall of the upper end part of the center pole 1b is filled with the magnetic fluid 4, and the fluid 4 is held therein as described above. At the time when the speaker device 100 is not driven, the voice coil 6 is held in a predetermined stationary position within the magnetic gap 9, i.e., in a position located within the winding width of the voice coil 6 and the width of the magnetic gap 9 according to the balance between the supporting force of the edge 8a and the buoyant force of the magnetic fluid 4 within the magnetic gap 9. Thereby, the first voice coil 6a, the second voice coil 6b, the recess portion 60, and part of the inner circumferential wall and the outer circumferential wall near the lower end part of the voice coil bobbin 5 are covered by the magnetic fluid 4.

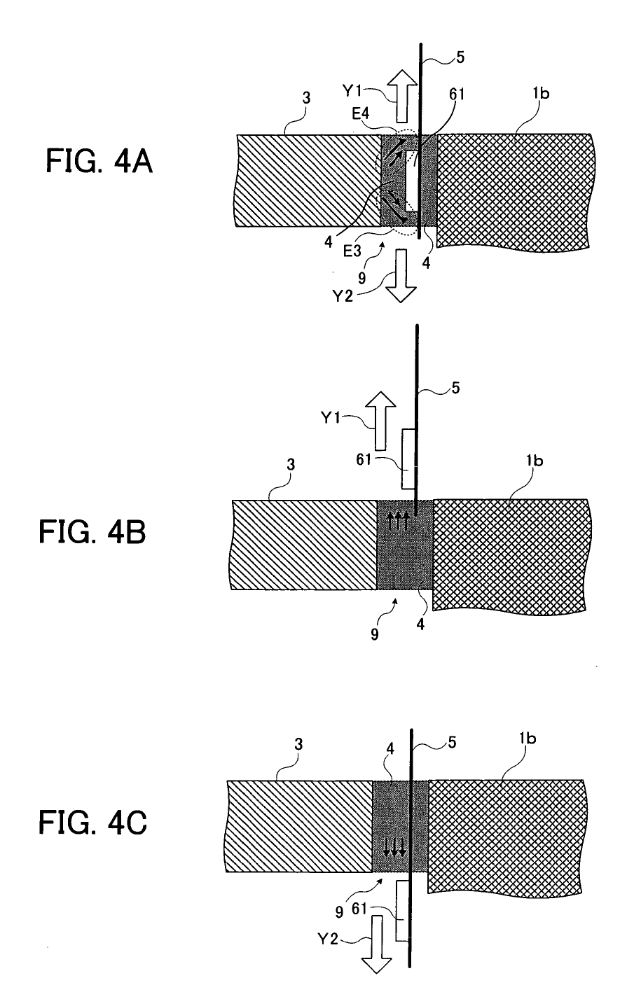

Next, the effect of the speaker device 100 according to the first embodiment of the invention will be described by referring to FIGS. 3 and 4A to 4C and comparing it with the effect of a speaker device according to a comparative example. Note that the configuration of the speaker device 100 according to the first embodiment and the speaker device according to the comparative example are basically the same, but the former and the latter are different only in the configuration of the voice coil 6. Accordingly, in the description regarding the latter, only the necessary parts are shown in the drawings, and the same reference numerals are assigned to the same constituent elements as those in the speaker device 100 according to the first embodiment and the detailed description thereof will be omitted. FIGS. 4A to 4C are partial sectional views of the respective constituent elements of the speaker device according to the comparative example, which correspond to the broken line area E1 of the speaker device 100.

FIG. 4A shows the location of the respective constituent elements when the speaker device according to the comparative example is not driven. FIGS. 4B and 4C are diagrams for explanation of the movement of the voice coil when an external force is applied to the respective constituent elements. Further, the arrows Y1 and Y2 shown in FIGS. 4A to 4C indicate the upward direction and downward direction of the speaker axis, respectively.

First, referring to FIGS. 4A to 4C, the configuration etc of the respective constituent elements according to the comparative example will be simply described.

As shown in FIGS. 4A to 4C, the inner circumferential wall of the annular plate 3 and the outer circumferential wall of the upper end part of the center pole 1b face each other with a certain distance therebetween, and the magnetic gap 9 is formed therein. The magnetic gap 9 is filled with the magnetic fluid 4. A voice coil 61 is wound around the outer circumferential wall of the lower end part of the voice coil bobbin 5 at a certain winding width. The voice coil 61 is located at a predetermined stationary position within the magnetic gap 9. Thereby, the voice coil 61 and part of the inner circumferential wall and the outer circumferential wall near the lower end part of the voice coil bobbin 5 are covered by the magnetic fluid 4.

In the speaker device of the comparative example having the above configuration, when it is not driven, the voice coil 61 is held in a predetermined stationary position within the magnetic gap 9 according to the balance between the supporting force of the edge 8a and the buoyant force of the magnetic fluid 4 within the magnetic gap 9 as shown in FIG. 4A. However, in such a speaker device, since the edge 8a is formed by soft material as in the first embodiment, the buoyant force of the magnetic fluid 4 is larger than the supporting force of the edge 8a for supporting the voice coil bobbin 5. Accordingly, when a slight external force is applied to the vibration system of the voice coil bobbin in the stationary condition in FIG. 4A, the voice coil 61 receives the buoyant force of the magnetic fluid 4 and is pushed out of the magnetic fluid 4. Such an effect will be specifically described.

After the driving of the speaker device is stopped, when a slight external force is applied in the direction of the arrow Y1 to the voice coil bobbin 5 in the condition shown in FIG. 4A, the magnetic fluid 4 tends to flow in the direction of the arrow shown by the broken line area E3 and concentrate in the lower end direction of the voice coil 61, and pushes out the voice coil 61 in the direction of the arrow Y1 by the buoyant force thereof. By the effect, the part near the lower end part of the voice coil bobbin 5 including the voice coil 61 is pushed out of the magnetic fluid 4 as shown in FIG. 4B.

On the other hand, after the driving of the speaker device is stopped, when a slight external force is applied in the direction of the arrow Y2 to the voice coil bobbin 5 in the stationary condition shown in FIG. 4A, the magnetic fluid 4 tends to flow in the direction of the arrow shown by the broken line area E4 and concentrate in the upper end direction of the voice coil 61, and pushes out the voice coil 61 in the direction of the arrow Y2 by the buoyant force thereof. By the effect, the part near the lower end part of the voice coil bobbin 5 including the voice coil 61 is pushed out of the magnetic fluid 4 as shown in FIG. 4C.

As described above, the edge 8a of the speaker device according to the comparative example is formed by soft material similarly to the speaker device 100 according to the first embodiment. Accordingly, as described above, when a slight external force is applied to the vibration system of the voice coil bobbin at the time when the speaker device is not driven, the voice coil 61 is displaced from the predetermined stationary position within the magnetic gap 9 due to the flow of the magnetic fluid 4. Therefore, in the speaker device according to the comparative example, it is difficult to hold the voice coil 61 at the predetermined stationary position within the magnetic gap 9 at the time when it is not driven.

Next, the effect of the speaker device 100 according to the first embodiment of the invention will be described. At the time when the speaker device 100 is driven, the voice coil bobbin 5 oscillates in the axis directions of the speaker device 100, i.e., the directions of the arrow Y1 and the arrow Y2 as shown in FIG. 3. Then, when driving the speaker device 100 is stopped from the condition, the magnetic fluid 4 flows into the recess portion 60 as indicated by arrows E5 and enters the recess portion 60 located between first voice coil 6a and the second voice coil 6b. That is, the greater part of the magnetic fluid 4 flows into the recess portion 60 and forms a stable condition because the amount within the recess portion 60 becomes larger than the amount in the other parts. Then, the voice coil 6 is held at a predetermined stationary position within the magnetic gap 9 according to the balance between the supporting force of the edge 8a and the buoyant force of the magnetic fluid 4 that has flown into the recess portion 60. Note that, in the speaker device 100, since the edge 8a is formed by soft material, the flowing force of the magnetic fluid 4 that tends to concentrate within the recess portion 60 and create a stable condition is larger than the supporting force of the edge 8a for supporting the voice coil bobbin 5.

In the speaker device 100 in such a stationary condition, when a slight external force is applied in the direction of the arrow Y1 or the arrow Y2 to the voice coil bobbin 5, the magnetic fluid 4 within the recess portion 60 tends to flow to the opposite sides, respectively, that is, flow into the recess portion 60 as indicated by the arrows E5 to restore the initial distribution condition according to its nature. Accordingly, the voice coil 6 is held at the predetermined stationary position within the magnetic gap 9. That is, the voice coil 6 is held at the position where the winding width thereof correspond to the width of the magnetic gap 9.

Therefore, in the speaker device 100 according to the first embodiment of the invention, even in the case where the edge 8a is formed by soft material, the voice coil 6 can be held reliably at a predetermined stationary position within the magnetic gap 9 by the above-described effect.

### Second Embodiment

In a speaker device 200 according to a second embodiment, a recess portion is formed on a voice coil bobbin located within the winding width of a voice coil provided within a magnetic gap. Thereby, the same effect as that in the speaker device 100 according to the first embodiment is obtained.

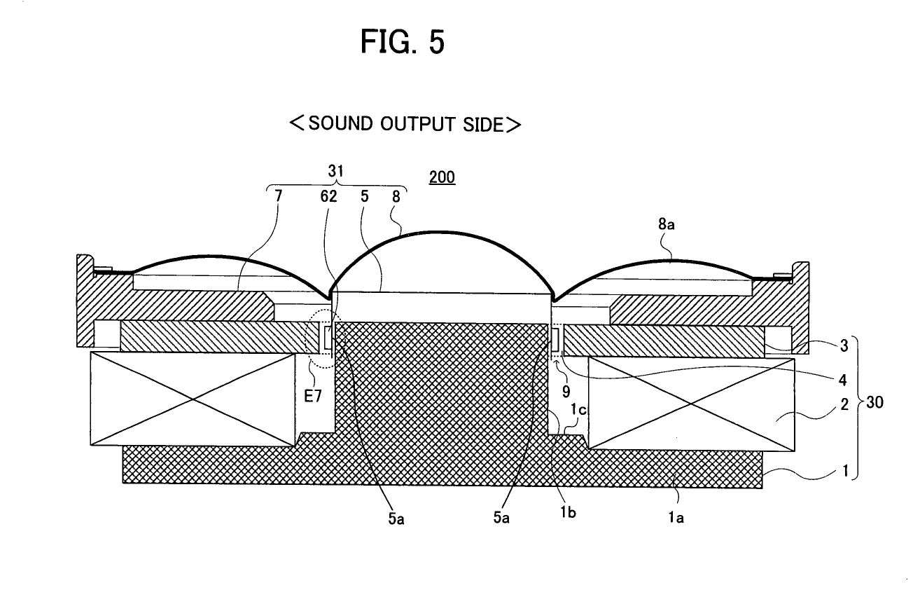

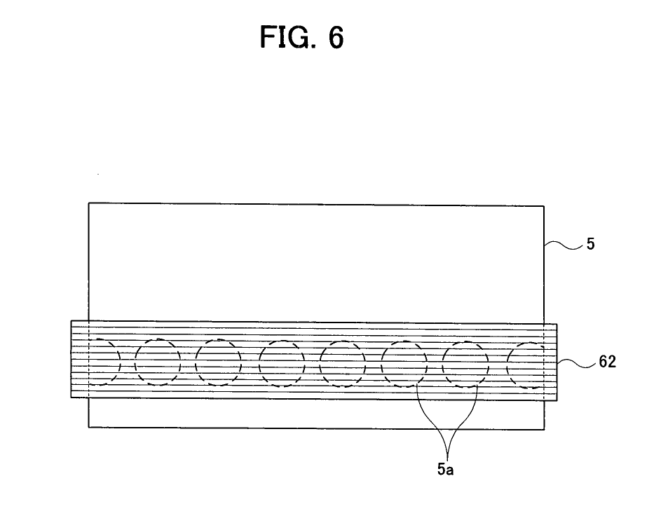

Referring to FIGS. 5 and 6, a configuration of the speaker device 200 according to the second embodiment will be described. FIG. 5 schematically shows an outline configuration of the speaker 200 according to the second embodiment of the invention. FIG. 6 is a side view showing only the configuration of a voice coil 62 wound around a voice coil bobbin 5 in the speaker device 200. The speaker device 200 according to the second embodiment has basically the same configuration as that of the speaker device 100 according to the first embodiment, and the former and the latter are different only in the configuration of the voice coil and the voice coil bobbin. Accordingly, in the description below, the same reference numerals are assigned to the same constituent elements as those in the speaker device 100 according to the first embodiment and the detailed description thereof will be omitted.

In the speaker device 200 according to the second embodiment, the voice coil 62 is wound around the outer circumferential wall of the lower end part of the voice coil bobbin 5 at a certain winding width. Further, the voice coil 62 is located at a predetermined stationary position within a magnetic gap 9 filled with magnetic fluid 4. Specifically, the voice coil 62 is located substantially at the center within the magnetic gap 9 as shown in FIG. 5. Especially, in the speaker device 200, a recess portion, for example, plural openings 5a are formed on the voice coil bobbin 5 located within the certain winding width of the voice coil 62. That is, in the second embodiment, the voice coil 62 is wound on the outer circumferential surface of the voice coil bobbin 5 having the plural openings 5a within the winding width of the voice coil 62, so as to cover the openings 5a. Further, the voice coil 62 and part of the inner circumferential wall and the outer circumferential wall near the lower end part of the voice coil bobbin 5 are covered by the magnetic fluid 4.

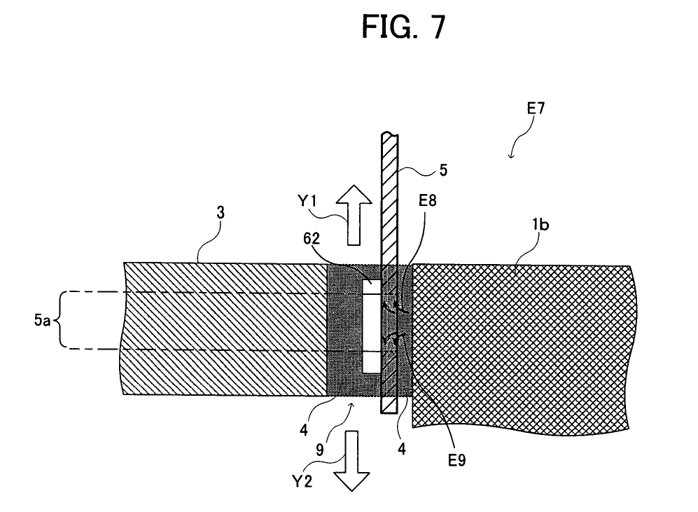

Next, referring to FIG. 7, the effect of the speaker device 200 according to the second embodiment will be described. FIG. 7 is a sectional view in which the part of the broken line area E7 in FIG. 5 is enlarged. The thickness of the voice coil bobbin 5 is emphatically shown for convenience.

At the time when the speaker device 200 is driven, the voice coil bobbin 5 oscillates in the axis directions of the speaker device 200, i.e., the directions of the arrow Y1 and the arrow Y2 as shown in FIG. 7. Then, when driving the speaker device 200 is stopped from the condition, the majority of the magnetic fluid 4 flows in the directions indicated by arrows E8 and E9 and enters the respective openings 5a. That is, the greater part of the magnetic fluid 4 flows into the openings 5a and forms a stable condition because the amount within the plural openings 5a becomes larger than the amount in the other parts. Then, the voice coil 62 is held at the above-described predetermined stationary position within the magnetic gap 9.

In the speaker device 200 in such a stationary condition, when a slight external force is applied in the direction of the arrow Y1 or the arrow Y2 to the voice coil bobbin 5, the magnetic fluid 4 within the respective openings 5a tends to flow to the opposite sides, respectively, that is, flows into the respective openings 5a as indicated by the arrows E8 and E9 restore the initial distribution condition according to its nature. Accordingly, the voice coil 62 is held at the predetermined stationary position within the magnetic gap 9.

Therefore, in the speaker device 200 according to the second embodiment of the invention, even in the case where the edge 8a is formed by soft material, the voice coil 62 can be held reliably at a predetermined stationary position within the magnetic gap 9 by the above-described effect.

### Third Embodiment

In a speaker device 300 according to a third embodiment, as constituent elements of a vibration system 31, a first annular member and a second annular member having annular shapes are provided. Further, the former is located at the upper side of a voice coil 6 and mounted to a voice coil bobbin 5, and the latter is located at the lower side of the voice coil 6 and mounted to the voice coil bobbin 5. Thereby, a recess portion is formed by the first and second annular members and the outer circumferential wall of the voice coil 6 located between them. Thereby, the same effect as that of the speaker device 100 according to the first embodiment is obtained.

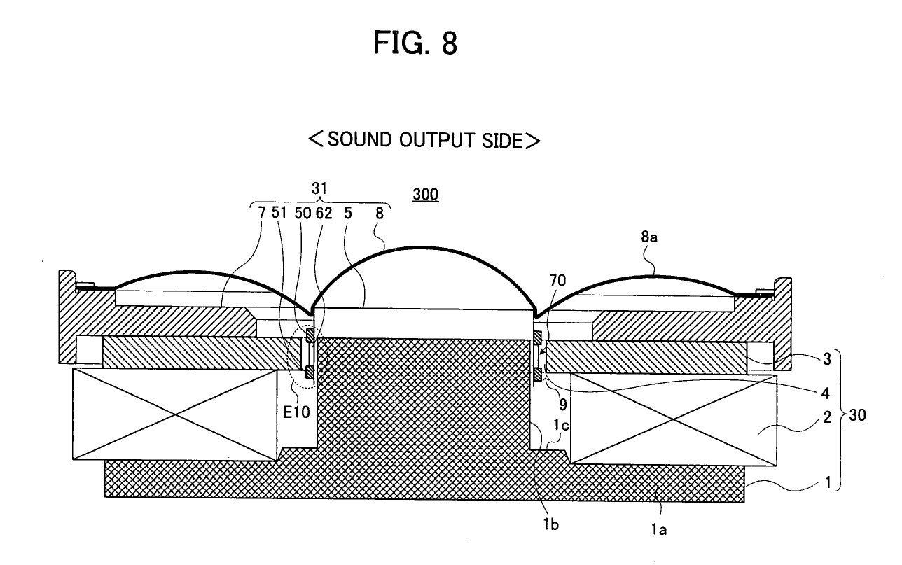

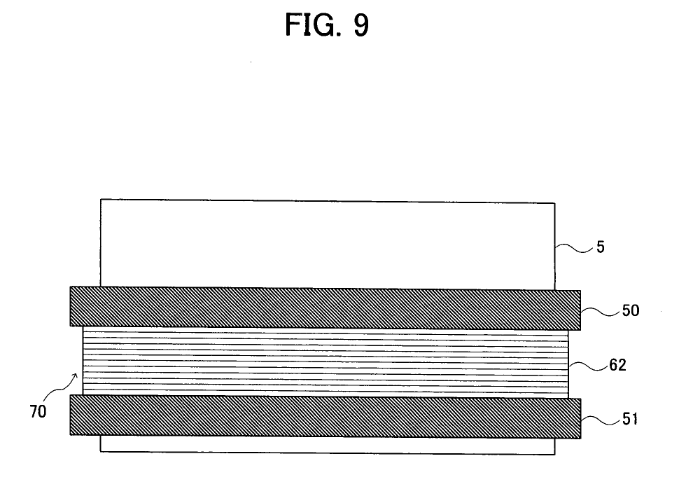

Referring to FIGS. 8 and 9, a configuration of the speaker device 300 according to the third embodiment will be described. FIG. 8 schematically shows an outline configuration of the speaker 300 according to the third embodiment of the invention. FIG. 9 is a side view showing only the configuration of a voice coil 62 wound around the voice coil bobbin 5 and first and second annular members 50 and 51 in the speaker device 300. The speaker device 300 according to the third embodiment has basically the same configuration as that of the speaker device 100 according to the first embodiment, and the former and the latter are different in the configuration of the vibration system 31 within the magnetic gap 9. In the description below, the same reference numerals are assigned to the same constituent elements as those in the speaker device 100 according to the first and second embodiments and the detailed description thereof will be omitted.

In the speaker device 300 according to the third embodiment, the voice coil 62 is located at a predetermined stationary position within the magnetic gap 9, that is, the voice coil 62 is located substantially at the center within the magnetic gap 9 like that in the speaker device 200 according to the second embodiment.

Especially, the speaker device 300 according to the third embodiment further has the first annular member 50 and the second annular member 51 as constituent elements of the vibration system 31. The first and second annular members 50 and 51 have inner diameters substantially the same as the outer diameter of the voice coil bobbin 5, and outer diameters larger than the outer diameter of the voice coil 62. Further, the first annular member 50 is located at the upper side of the voice coil 62 and mounted to the voice coil bobbin 5. On the other hand, the second annular member 51 is located at the lower side of the voice coil 62 and mounted to the voice coil bobbin 5. That is, as shown in FIG. 9, the annular members 50 and 51 are thicker than the voice coil 62 and have sectional shapes protruding outside the voice coil 62. Thereby, a recess (concave) portion 70 is formed by the first annular member 50, the second annular member 51, and the outer circumferential wall of the voice coil 62 located between them. By the way, as material for the first and second annular members 50 and 51, a non-magnetic material of resin, paper or the like is appropriate.

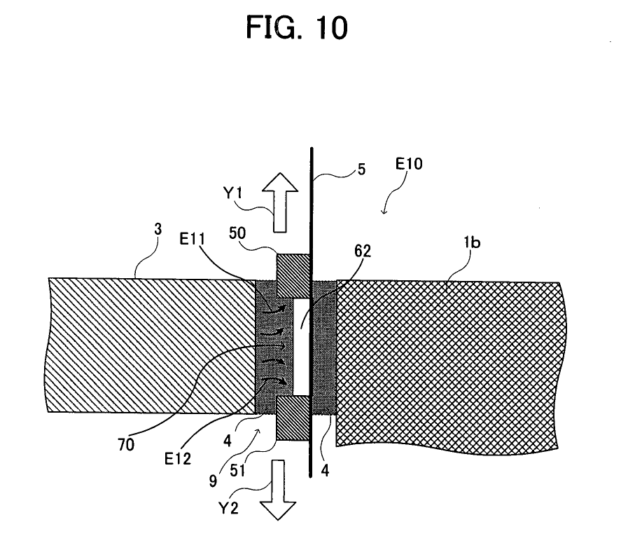

Next, referring to FIG. 10, the effect of the speaker device 300 according to the third embodiment will be described. FIG. 10 is a sectional view in which the part of the broken line area E10 in FIG. 8 is enlarged.

At the time when the speaker device 300 is driven, the voice coil bobbin 5 oscillates in the axis directions of the speaker device 300, i.e., the directions of the arrow Y1 and the arrow Y2 as shown in FIG. 10. Then, when driving the speaker device 300 is stopped from the condition, the magnetic fluid 4 flows as indicated by arrows E11 and E12 and enters the recess portion 70. That is, the greater part of the magnetic fluid 4 flows into the recess portion 70 and forms a stable condition because the amount within the recess portion 70 becomes larger than the amount in the other parts. Then, the voice coil 62 is held at the above-described predetermined stationary position within the magnetic gap 9.

In the speaker device 300 in such a stationary condition, when a slight external force is applied in the direction of the arrow Y1 or the arrow Y2 to the voice coil bobbin 5, the magnetic fluid 4 within the recess portion 70 tends to flow to the opposite sides, respectively, that is, flow in the direction indicated by the arrow E12 or the direction indicated by the arrow E11 into the recess portion 70 to restore the initial distribution condition according to its nature. Accordingly, the voice coil 62 is held at the predetermined stationary position within the magnetic gap 9.

Therefore, in the speaker device 300 according to the third embodiment of the invention, even in the case where the edge 8a is formed by soft material, the voice coil 62 can be held reliably at a predetermined stationary position within the magnetic gap 9 by the above-described effect.

### MODIFIED EXAMPLE

In the above-described respective embodiments, the invention is applied to the speaker device having the domical vibrating plate suitable for treble reproduction, however, not limited to that, the invention can be also applied to a speaker device having a conical vibrating plate for bass reproduction.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2004-182580 filed on Jun. 21, 2004 including the specification, claims, drawings and summary is incorporated herein by reference in its entirety.

1. A speaker device comprising:
a magnetic circuit having a magnetic gap;
a vibration unit having a voice coil bobbin and a voice coil wound around the voice coil bobbin; and
magnetic fluid filled in the magnetic gap,
wherein a recess portion is formed in a part of the vibration unit located within the magnetic gap.

2. The speaker device according to claim 1, wherein the voice coil has a first voice coil and a second voice coil wound around the voice coil bobbin within a winding width of the voice coil, the first voice coil being wound at an upper end side of the voice coil bobbin and the second voice coil being wound at a lower end side of the voice coil bobbin, and
wherein the recess portion is formed by the first voice coil, the second voice coil and the outer circumferential surface of the voice coil bobbin located between the first voice coil and the second voice coil.

3. The speaker device according to claim 1, wherein the recess portion is formed by plural openings formed on the voice coil bobbin within a winding width of the voice coil.

4. The speaker device according to claim 1, wherein the vibration unit has first and second annular members mounted to the voice coil bobbin at an upper position and a lower position of the voice coil and having thickness thicker than that of the voice coil, and
wherein the recess portion is formed by the first annular member, the second annular member and the outer circumferential surface of the voice coil located between the first annular member and the second annular member.

5. The speaker device comprising:
a magnetic circuit having a magnetic gap;
a vibration unit having a voice coil bobbin and a voice coil wound around the voice coil bobbin; and
magnetic fluid filled in the magnetic gap,
wherein the vibration unit has a shape in which an amount of the magnetic fluid located substantially at a center of a width of the magnetic gap is larger than amounts of the magnetic fluid located in other parts.
